(19) United States
(12) Patent Application Publication
(10) Pub. No.: US 2015/0329665 A1
(43) Pub. Date: Nov. 19, 2015

(54) NOVEL HYDROPHILIC POLYMER FORM COMPRISING MALTODEXTRIN

(71) Applicant: LABORATOIRES URGO, Chenove (FR)

(72) Inventor: Jean-Marc Henri Maurice PERNOT, Dijon (FR)

(21) Appl. No.: 14/653,209

(22) PCT Filed: Dec. 16, 2013
(86) PCT No.: PCT/FR2013/053091

§ 371 Date: Jun. 17, 2015

(30) Foreign Application Priority Data
Dec. 18, 2012 (FR) 1262193

(51) Int. Cl. C08G 18/08; C08L 75/04; C08L 3/02; C08G 18/06

(52) U.S. Cl. CPC C08G 18/14; C08G 18/06; C08L 75/04; C08L 3/02; C08G 2101/00

(57) ABSTRACT

The present invention relates to a novel hydrophilic polymer foam comprising maltodextrin, the wickability properties of which are improved with respect to a conventional hydrophilic polymer foam. The present invention can be used in the field of personal hygiene products, hygienic devices of the type of diapers, tampons, wipes, or also sanitary towels, but also in the fields of cosmetics, dressings or horticulture.

The present invention relates to a novel hydrophilic polymer foam comprising maltodextrin, the rate of absorption of a liquid of which is improved with respect to a conventional hydrophilic polymer foam.

The present invention has applications in the fields of health and safety, in particular in devices for which effective absorption of biological fluids is necessary. The present invention has applications in particular in the field of dressings, personal hygiene products, hygienic devices of the type of diapers, sanitary towels, tampons or wipes.

The invention also has an application in the fields of cosmetics and horticulture.

### PRIOR STATE OF THE ART

The wickability or wick effect of a foam is generally defined as the time taken by a precise amount of liquid to be absorbed at the surface of the foam and to spread into its volume. This intrinsic characteristic of the hydrophilic polymer foam proves to be particularly determining in the medical field, for example for taking care of weeping wounds which release exudates, but also in the fields of hygienic products and of horticulture, where the management of fluids is a major issue.

In the hygiene field, it is desirable to use hygienic devices which are capable of absorbing biological fluids but which are also capable of moving them away from the surface of the skin. The skin of people, which is thus protected from any moisture, is no longer subject to irritation or to redness, for example in the case of exposure to a diaper soiled with urinary secretions.

In the field of horticulture, properties of absorption, indeed even also of retention, of water prove to be particularly favorable to better rooting of the plant and to a reduction in the intervals for irrigation of a plant.

From a medical viewpoint, it is known that the exudates of wounds have in the majority of cases a tendency to decrease as the wound heals. However, in some cases, the amount of exudates can increase as the healing advances and can disrupt the satisfactory progress thereof. It is thus necessary to have available a medical device having good wick effect properties in order for the exudates to be absorbed relatively rapidly by the latter and thus for the exudates, during the positioning of the dressing, not to be forced into contact with the perilesional skin which is healthy, in order thus to prevent it from being soaked.

In order to respond to these issues of management of the fluids, the improvement in the wickability properties of a foam thus represents a major point of interest. It is thus necessary for the majority of manufacturers to design ever more advanced foams having improved wickability properties.

It is thus possible to find a great many documents in the literature describing absorbent foams responding to this issue.

The conventional absorbent foams which are most commonly incorporated in dressings are cellular materials made of polyurethane. Hydrophilic polyurethane foams are generally prepared by polymerization of a hydrophilic prepolymer having isocyanate end groups which are active in the presence of water.

Thus, for example, the document U.S. Pat. No. 4,740,528 describes a composition for the manufacture of a hydrophilic polyurethane foam comprising amino acids, the wickability properties of which are improved. The foam is obtained from a prepolymer of poly(alkyleneoxy)polyol type comprising isocyanate end groups, placed in aqueous solution, the pH of which does not exceed 8. The prepolymer is combined with at least one amino acid having a carboxylic acid group. The carboxylic acid groups of the amino acid contribute improved hydrophilic properties to the foam.

In the context of the present invention, the wickability of polymer foams has been improved by choosing a simpler alternative to carry out, the manufacture of the foam which is the subject matter of the present invention being freed from any pH constraint.

Entirely surprisingly, it has been noticed that the introduction of maltodextrin within a polymer foam confers wick effect properties on said polymer foam, thus responding to the issue set out above.

The present invention thus consists of a novel hydrophilic polymer foam, in particular a hydrophilic polyurethane foam, comprising maltodextrin.

The document WO 2007/095713 describes a foam made of biodegradable hydrophobic polyurethane obtained by mixing polyhydroxybutyrates, polyols and isocyanates. The use of maltodextrin as polyol is suggested in this document. The maltodextrin, used as reaction intermediate in the same way as the isocyanates, reacts chemically with the isocyanates to form polyurethane molecules. The maltodextrin is thus not found in the foam in the native form. Furthermore, the hydrophobicity of such a foam does not allow the latter to meet prerogatives of wickability.

The application WO 2008/157711 from the company Rynel describes, in a specific embodiment, a nonwoven on which capsules of active principles have been deposited. The capsules are attached to the nonwoven by casting on top a hydrophilic or hydrophobic polyurethane foam which makes it possible to preserve them and to protect them. Once the dressing has been applied to a wound, the capsules trapped at the interface of the nonwoven and of the foam dissolve on contact with the exudates and liberate the active principle, which is released over the wound. Polymers of the polyethylene oxide type are preferably used to encapsulate the active principles.

Furthermore, maltodextrin is known to absorb good amounts of oil. It is generally used as swelling agent, encapsulating agent, filler, excipient or flavor support. It is also known to be a sorption agent in the intestines and to make possible better assimilation of various nutrients in the intestines, as a result of which it is very frequently taken by athletes.

Thus, no document has to date described a hydrophilic polymer foam comprising maltodextrin. Neither has it been suggested in the prior art to improve the wick effect of a foam by incorporating maltodextrin therein.

### SUMMARY OF THE INVENTION

Thus, the present invention consists of a novel hydrophilic polymer foam, characterized in that it comprises maltodextrin. Hydrophilic polymer foam is understood here to mean a cellular material obtained by polymerization reaction and possessing properties of absorbing aqueous liquids.

The polymer foam can be chosen from hydrophilic polyurethane foams and polyvinyl alcohol (PVA) foams.

According to a preferred embodiment, the invention consists of a hydrophilic polyurethane foam comprising an amount of maltodextrin of between 1 and 50% by weight, preferably between 3 and 20% by weight and more preferably between 3 and 10% by weight, of the final weight of said foam.

According to another aspect, a subject matter of the invention is the use of maltodextrin as wickability agent in a hydrophilic polymer foam, in particular when this foam is included in a dressing of the hydrocellular or hydrocolloid type.

According to yet another of its aspects, the invention relates to a process for the preparation of a hydrophilic polymer foam which consists in preparing a reaction mixture comprising monomers or a prepolymer intended to polymerize and in bringing together said mixture and maltodextrin.

### DETAILED DESCRIPTION OF THE INVENTION

Other characteristics and advantages of the invention will become more clearly apparent on reading the description which follows of a preferred embodiment of the invention, given by way of example.

Thus, the present invention consists of a novel hydrophilic polymer foam, characterized in that it comprises maltodextrin. The hydrophilic polymer foam can be chosen from hydrophilic polyurethane foams or polyvinyl alcohol (PVA) foams.

According to one embodiment, the foam is a hydrophilic polyurethane foam.

A hydrophilic polyurethane foam can be produced from a precursor mixture in the form of an aqueous dispersion comprising either monomers or prepolymers.

The prepolymer of the hydrophilic polyurethane foam may be already synthesized. On the other hand, if the prepolymer has to be prepared, it is possible to produce the hydrophilic polyurethane foam in one or two stages. In one stage, the hydrophilic polyurethane foam is produced by reacting the polyols, the polyisocyanates, water and a surfactant simultaneously. In two stages, the prepolymer is synthesized in a stage prior to the addition of water and of surfactant, by reacting the polyols and the polyisocyanates.

If the prepolymer is already synthesized, it is sufficient simply to react the latter with water and a surfactant in order to obtain a hydrophilic polyurethane foam. It should be noted that the surfactant does not constitute an essential compound with regard to the preparation of a hydrophilic polyurethane foam; it is only optional but plays a major role with regard to the control of the reaction and with regard to the physicochemical characteristics of the foam obtained.

“Polyol” is understood to mean, within the meaning of the present invention, any natural or synthetic compound exhibiting several hydroxyl groups, said groups being capable of reacting with isocyanates groups to result in urethane bridges. In the case of polyols of synthetic origin, polyethylene glycol and polyethers are the most frequently used by manufacturers of hydrophilic polyurethane foams, in particular due to their hydrophilicity. In the case of polyols of natural origin, the latter can be derived from the products defined by the following nonlimiting list: xylose, arabinose, glucose, sucrose, dextrins, glycerol, starch, castor oil, soybean oil or vegetable oil. In the context of the present invention, the polyols preferably used will be of the poly(ethyleneoxy)polyol or poly(propyleneoxy)polyol type or a mixture of the two.

“Polyisocyanates” is understood to mean any compound which can be chosen from the group consisting of toluene 2,4-diisocyanate, toluene 2,6-diisocyanate, ethylidene diisocyanate, propylene 1,2-diisocyanate, cyclohexylene 1,2-diisocyanate, cyclohexylene 1,4-diisocyanate, triphenylmethane 4,4′,4″-triisocyanate, m-phenylene diisocyanate, 4,4′-biphenylene diisocyanate, 3,3′-dichloro-4,4′-biphenylene diisocyanate, benzene 1,3,5-triisocyanate, toluene 2,4,6-triisocyanate, diphenyl 2,4,4′-triisocyanate, 1,4-tetramethylene diisocyanate, 1,6-hexamethylene diisocyanate, 1,10-decamethylene diisocyanate, xylene diisocyanate, chlorophenylene diisocyanate, diphenylmethane 4,4′-diisocyanate, naphthalene 1,5-diisocyanate, cumene 2,4-diisocyanate, 4-methoxy-1,3-phenylene diisocyanate, 4-chloro-1,3-phenylene diisocyanate, 4-bromo-1,3-phenylene diisocyanate, 4-ethoxy-1,3-phenylene diisocyanate, 4-bromo-1,3-phenylene diisocyanate, 4-ethoxy-1,3-phenylene diisocyanate, 2,4-diisocyanatodiphenyl ether, 5,6-dimethyl-1,3-phenylene diisocyanate, 2,4-dimethyl-1,3-phenylene diisocyanate, 4,4′-diisocyanatodiphenyl ether, benzidine diisocyanate, xylene α,α-diisothiocyanate, 3,3′-dimethyl-4,4′-biphenylene diisocyanate, 2,2′,5,5′-tetramethyl-4,4′-biphenylene diisocyanate, 4,4′-methylene-bis(phenyl isocyanate), 4,4′-sulfonylbis(phenyl isocyanate), 4,4′-methylenedi(o-tolyl isocyanate), ethylene diisocyanate, ethylene diisothiocyanate and trimethylene diisocyanate.

The constituent prepolymers of a hydrophilic polyurethane foam are preferably of poly(alkyleneoxy)polyol type. Among these prepolymers, polyurethane prepolymers comprising isocyanate end bonds are particularly preferred, such as, for example, the prepolymers sold under the Hypol® brand by Dow, the Prepol® brand by Lendell Manufacturing Inc., the Hydropol® brand by Mace Adhesives & Coatings Co., the Aquapol® brand by Carpenter Co. and the Urepol® brand by EnviroChem Technologies. These isocyanate end bonds can correspond to aromatic isocyanates, such as, for example, toluene diisocyanate (TDI) or methylenediphenyl diisocyanate (MDI), or also to aliphatic isocyanate groups, such as, for example, isophorone diisocyanate (IPDI) but also hydrogenated methylenediphenyl diisocyanate (HMDI). The products of the Hypol® brand which can be used in the context of the present invention include Hypol 2000®, Hypol 2002 E®, Hypol 3000®, Hypol 4000® or Hypol 5000®. Preferably, in the context of the present invention, the prepolymer used in the preparation of the hydrophilic polyurethane foam will be Hypol 2002 E®.

The precursor mixture of the foam can comprise a surfactant of cationic, anionic or nonionic type or also a silicone-based surfactant.

A wide variety of surfactants known in the state of the art can be provided with regard to its incorporation in the preparation of a hydrophilic polyurethane foam. Among known surfactants, cationic surfactants, nonionic surfactants or also anionic surfactants, such as salts of fatty acids, salts of esters of sulfuric acids, salts of esters of phosphoric acids and sulfonates, can be present in the base composition which is a subject matter of the present invention. Preferably, the surfactants used in the context of the preparation of a hydrophilic polyurethane foam will be surfactants of nonionic type, such as some products sold by BASF under the Pluronic® name. More preferably still, the surfactant used in the preparation of a hydrophilic polyurethane foam is Pluronic PE6200®, which is a copolymer of ethylene oxide and of propylene oxide, or also Pluronic PE6800 ®. Another known type of surfactant which can be used in the context of the present invention is represented by silicone-based surfactants. Mention may be made, among these, of hydrolysable polysiloxane/polyoxyalkylene copolymers, nonhydrolyzable polysiloxane/polyoxyalkylene copolymers, cyanoalkylpolysiloxanes, alkylpolysiloxanes, polydimethylsiloxanes and polyoxyalkylene-modified dimethylpolysiloxanes. The type of silicone-based surfactant used and the amount necessary depend on the type of foam to be produced.

The maltodextrin used in the context of the present invention is a product of hydrolysis of starch. Once mixed with the precursor monomers or prepolymers of the hydrophilic polymer foam, the maltodextrin advantageously retains its native form: it does not react chemically with the constituents of the foam and is found spread out through the whole of the foam thus produced. The maltodextrin is preferably distributed through the whole of the body of the foam.

The maltodextrin preferably exhibits a dextrose equivalent (D.E.) of less than or equal to 20. It occurs in the form of an odorless powder of neutral taste which can be represented by the following formula:

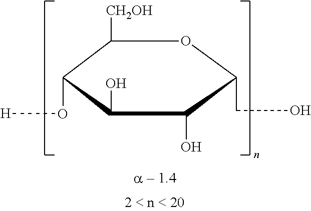

It is preferable to use a maltodextrin having a very good dispersion and a better solubility in water. The maltodextrin thus preferably has a particle size of between 40 and 500 μm.

The maltodextrin introduced into the foam of the present invention is, for example, of the Glucidex® brand produced by Roquette.

The maltodextrin is preferably included within the hydrophilic polymer foam at between 1 and 50% by weight, preferably between 3 and 20% by weight, for example between 3 and 10% by weight, of the total weight of the foam.

Another subject matter of the invention is a process for the preparation of a hydrophilic polymer foam which consists in preparing a reaction mixture comprising monomers or a prepolymer intended to polymerize and in bringing together said mixture and maltodextrin.

The maltodextrin can be incorporated in the hydrophilic polyurethane foam either in the powder form, during a stage prior to the synthesis of said foam, or mixed in an aqueous phase, that is to say introduced in a solution of surfactant and distilled water.

According to a specific embodiment, the hydrophilic polymer foam of the invention is obtained by incorporating the maltodextrin (in the solid form or in the solution form) in a solution of monomers or prepolymer, so that the polymerization reaction takes place in the presence of the maltodextrin. In order to produce a hydrophilic polyurethane foam having improved wickability properties, it is sufficient to mix, in a receptacle, a large amount of distilled water and surfactant and then to homogenize said preparation. In a second stage, a preestablished amount of this preparation is taken and maltodextrin is added thereto. Everything is mixed using a mixer and then, in a third stage, prepolymer is added. The preparation thus obtained is again mixed in a mixer and then swelling is allowed to take place or the preparation is poured between two sheets of silicone-treated paper and the product is put in an oven for a prolonged period of time.

It is also possible to produce a hydrophilic polyurethane foam by depositing, during a first step, the maltodextrin in the powder form at the bottom of the receptacle before casting a reaction mixture based on surfactant, water and prepolymer.

There exist several processes for obtaining a hydrophilic polyurethane foam.

Conventionally, in industry, hydrophilic polyurethane foams are produced according to in particular two types of processes, a process which makes it possible to obtain such a foam in the “mat” form, which foam will, in a second step, be cut to a desired value of thickness, and a controlled thickness process in which the foam is obtained directly at a desired value of thickness. In the laboratory, in order to mimic these two types of processes, foams are produced in the “mushroom” form in order to reproduce the process for producing foam in the mat form, and foams are produced in the plaque form in order to reproduce on a small scale a controlled thickness process for producing foam. If it is desired to obtain a foam in the plaque form, it is sufficient to cast the foam obtained at the end of the third stage described above between two sheets of silicone-treated paper separated on each side by blocks, the thickness of which corresponds to the thickness desired for the foam, and on which, on its upper surface, is affixed a plate and also a weight which makes it possible to limit the vertical ascent of said foam. If it is desired to obtain a foam in the mushroom form, it is sufficient simply to leave the foam to swell in a receptacle during the final stage and to allow it to gain height, without, of course, spreading it.

The wickability of the hydrophilic polymer foam can be evaluated according to the following test, preferably when the foam is obtained by a process of “mat” type. The foam is cut into several slices and the test for measuring the wick effect is carried out on each of the slices, in order to monitor that the rate of absorption is indeed the same over all the levels of the foam. A solution based on distilled water and dye is prepared, a predetermined volume of which solution is poured over the surface of the chosen slice of foam. The time taken for this solution to be completely absorbed is calculated. The absorption time for a given volume is thus obtained. This makes it possible to determine the rate taken by a drop having the volume x to be absorbed and to thus define the value given to the wickability or wick effect of the foam.

It is necessary to compare these rates of absorption of a hydrophilic polymer foam comprising maltodextrin with a negative control, a control consisting of a hydrophilic polyurethane foam of the same type as that of the subject of the test, minus the presence of maltodextrin.

When the foam is obtained in the plaque form, the wickability test to be applied is exactly the same as that described above. The cutting stage is omitted and the absorption time on each of the faces is simply measured.

The subject matter of the present invention has a preferred application in the provision of dressings for the absorption of the exudates from wounds. This is because the maltodextrin incorporated in a hydrophilic polyurethane foam promotes the absorption of the exudates from the patient's wound. The foam constitutes the main layer of the dressing or one of the layers of the dressing. Thus, the hydrophilic polymer foam comprising maltodextrin can be used in the manufacture of dressings of hydrocellular or hydrocolloid type.

Another subject matter of the invention is thus a hydrocellular or hydrocolloid dressing comprising a hydrophilic polymer foam comprising maltodextrin as described above.

The invention also relates to the use of maltodextrin as wickability agent in a hydrophilic polymer foam, in particular when the foam forms part of a dressing of the hydrocellular or hydrocolloid type. In this embodiment, the maltodextrin can also be used as agent which promotes absorption of the exudates from a wound on which the dressing is applied.

The foam of the invention can be used more generally for any application which requires absorption of liquids, such as water or also various urinary secretions. In this context, it proves to be particularly useful in horticulture, where the absorption of water and its retention makes it possible to reduce the intervals of irrigation or also makes possible better rooting of the plant, but also in various hygienic devices, of diaper type, where absorption of liquid by the foam is its removal from the surface makes it possible not to keep such a wet device in contact with the skin, and thus to prevent the appearance of a great many lesions.

### EXAMPLES

### Example 1

### Hydrophilic Polyurethane Foam Comprising Maltodextrin

Manufacture of the Foam

2 g of Pluronic 6200® are added to 98 g of distilled water and then the mixture is homogenized using a conventional propeller mixer at 500 revolutions/min. 30 g of this aqueous phase are taken and 1 g of Glucidex IT 12® is added thereto (in this case, the hydrosoluble compound is “aqueous-phase mixed”). Mixing is carried out in the beaker for seconds, still using a conventional propeller mixer, at 300 revolutions/min and then 15 g of Hypol 2002 E® are subsequently added. Everything is stirred at 800 revolutions/min for 20 seconds using the propeller mixer. The foam is allowed to swell until at maximum expansion and then placed in an oven at 70° C. for at least 4 hours. A hydrophilic polyurethane foam comprising maltodextrin is thus obtained, which maltodextrin is mixed in the aqueous phase, in the mushroom form.

It should be noted that Glucidex IT 12® in the powder form can be deposited beforehand at the bottom of the beaker, into which beaker the constituent reaction mixture of the foam will be cast in a second step. It thus concerns depositing 1 g of Glucidex IT 12® at the bottom of a beaker. The constituent mixture of the polyurethane foam is subsequently cast onto this powder so as to obtain a foam comprising maltodextrin in the mushroom form, that is to say that the foam is not spread out; the latter swells and thus gains height.

It is also possible to produce a foam in the plaque form. The only difference with respect to the process for obtaining a foam in the mushroom form, whether the water-soluble compound is “aqueous-phase mixed” or deposited in the powder form, lies in the final stage. At this point, the foam is cast between two sheets of silicone-treated paper separated on each side by blocks having the thickness which is desired to give to the foam, for example 4 mm, and on which foam there is affixed, at its upper surface, a plate and also a weight which make it possible to limit the vertical ascent of said foam. After expansion, this combination is placed in an oven at 70° C. for at least 4 h.

Method of Measuring the Wickability of the Hydrophilic Polyurethane Foam Comprising Maltodextrin Produced in the Mushroom Form

Once the foam has been cast in the mushroom form, the foam is cut into 3 or 4 slices in the direction of its height. The test for measuring the wick effect of a liquid will be carried out on each slice of the mushroom, the aim being to see if this wick effect is identical over the entire height of the foam.

To do this, it is sufficient to pour a small amount of distilled water into a beaker and to add a small amount of dye E131 in order to be able to visualize the absorption of the colored drop. 200 μl of this solution are withdrawn using a syringe and the contents of the syringe are poured onto the test sample and the stopwatch is started. When the liquid is completely absorbed, the stopwatch is then stopped. The time for absorption of a drop of 200 μl is thus obtained. The wick effect of said slice of foam is thus obtained.

Measurement of the Wickability of a Hydrophilic Polyurethane Foam Comprising Maltodextrin Produced in the Mushroom Form

When the water-soluble compound is in the powder form at the start of the preparation of the foam, the wickability measured is 15 seconds and this is the case for all the slices of the mushroom, with the exception of one, the top slide of the mushroom, where the absorption of the liquid is slightly longer. This is very probably due to “the skin effect” which is formed on the top of the foam, this being the case even if Glucidex IT 12® is diffused throughout the height of the mushroom.

When the water-soluble compound is aqueous-phase mixed at the start of the preparation of the foam, the wickability measured is 20 seconds over all the slices, even the top slice of the mushroom. The Glucidex IT 12® is diffused throughout the height of the mushroom.

Method for Measuring the Wickability of a Hydrophilic Polyurethane Foam Comprising Maltodextrin Produced in the Plaque Form

Once the foam has been cast in the plaque form, the stage of cutting applied to the foam obtained in the mushroom form is omitted. The test for measuring the wick effect of a liquid will be carried out directly on each of the two faces of the foam obtained in the plaque form, the aim being to see if this wick effect is identical on each side of the foam.

To do this, it is sufficient to pour a small amount of distilled water into a beaker and to add a small amount of dye E131 in order to be able to visualize the absorption of the colored drop. 200 μl of this solution are withdrawn using a syringe and the contents of the syringe are poured onto the test sample and the stopwatch is started. When the liquid is completely absorbed, the stopwatch is then stopped. The time for absorption of a drop of 200 μl is thus obtained. The wick effect of said foam obtained in the plaque form is thus obtained.

Measurement of the Wickability of a Hydrophilic Polyurethane Foam Comprising Maltodextrin Produced in the Plaque Form

When the water-soluble compound is in the powder form at the start of the preparation of the foam, the wickability measured is between 45 seconds and 1 minutes 20 seconds on the face of the foam which has been in contact with Glucidex IT 12®.

### Comparative Example 2

Foam in the mushroom form

| | Amount of | Negative control |
|---|---|---|
| | maltodextrin in | (absence of |
| Wickability test | the sample = 1 g | maltodextrin) |
| Maltodextrin | 15 seconds | Greater than |
| introduced in the | | 2 minutes |
| powder form | | |
| Aqueous-phase mixed | 20 seconds | |
| maltodextrin | | |

The results obtained in the context of the present invention are beautiful and very significant of the fact that maltodextrin increases the absorption kinetics capabilities of a hydrophilic polyurethane foam. This is because the rates of absorption of the colored water drop with a volume of 200 μl deposited at the surface of a hydrophilic polyurethane foam comprising maltodextrin, whether it is introduced in the powder form or in the aqueous-phase mixed form, are between 15 and 20 seconds. The negative control, the hydrophilic polyurethane foam not comprising maltodextrin, for its part has absorption kinetics of greater than 2 minutes. Thus, these results clearly corroborate the fact that maltodextrin has a role of wickability agent in a hydrophilic polymer foam.

### Comparative Example 3

Foam in the plaque form

| | Amount of | |
|---|---|---|
| | maltodextrin in | Negative control |
| | the sample = | (absence of |
| Wickability test | 20 and 60 g/m² | maltodextrin) |
| Maltodextrin | 1 minute | Greater than |
| introduced in the | 20 seconds | 2 minutes |
| powder form at an | | |
| amount of 20 g/m² | | |
| Maltodextrin | 45 seconds | |
| introduced in the | | |
| powder form at an | | |
| amount of 60 g/m² | | |

The results obtained in the context of the present invention are beautiful and very significant of the fact that maltodextrin increases the absorption kinetics capabilities of a hydrophilic polyurethane foam. This is because the rates of absorption of the colored water drop with a volume of 200 μl deposited at the surface of a hydrophilic polyurethane foam comprising maltodextrin are between 45 and 80 seconds. The negative control, the hydrophilic polyurethane foam not comprising maltodextrin, for its part has absorption kinetics of greater than 2 minutes. Thus, these results clearly corroborate the fact that maltodextrin has a role of wickability agent in a hydrophilic polymer foam.

1. A hydrophilic polymer foam, which comprises maltodextrin.

2. The foam as claimed in claim 1, wherein the foam is a hydrophilic polyurethane foam.

3. The foam as claimed in claim 1, which comprises an amount of maltodextrin of between 1 and 50% by weight, preferably between 3 and 20% by weight and more preferably between 3 and 10% by weight, of the total weight of said foam.

4. The foam as claimed in claim 1, wherein the maltodextrin is distributed through the whole of the body of the foam.

5. The foam as claimed in claim 1, wherein the maltodextrin exhibits a dextrose equivalent of less than or equal to 20 or a particle size of between 40 and 500 microns.

6. A hydrocellular or hydrocolloid dressing comprising a hydrophilic polymer foam in accordance with claim 1.

7. The use of maltodextrin as wickability agent in a hydrophilic polymer foam.

8. The use as claimed in claim 7, in which the foam forms part of a dressing of the hydrocellular or hydrocolloid type.

9. The use as claimed in claim 8, wherein the maltodextrin is also used as agent which promotes absorption of the exudates from a wound on which the dressing is applied.

10. A process for the preparation of a hydrophilic polymer foam which consists in preparing a reaction mixture comprising monomers or a prepolymer intended to polymerize and in bringing together said mixture and maltodextrin.
